(19) United States
(12) Patent Application Publication
(10) Pub. No.: US 2023/0068962 A1
(43) Pub. Date: Mar. 2, 2023

(54) VEHICLE FILTER MONITORING SYSTEMS AND METHODS

(71) Applicant: Donaldson Company, Inc., Bloomington, MN (US)

(72) Inventors: Nathan D. Zambon, Cedar Falls, IA (US); Daniel E. Adamek, Bloomington, MN (US); Bradly G. Hauser, Minneapolis, MN (US); Chad M. Goltzman, Bloomington, MN (US); Michael J. Wynblatt, Minneapolis, MN (US)

(21) Appl. No.: 17/876,368

(22) Filed: Jul. 28, 2022

Related U.S. Application Data
(60) Provisional application No. 63/227,198, filed on Jul. 29, 2021.

(51) Int. Cl. G07C 5/10; G01S 19/13; G01C 21/34; G07C 5/00

(52) U.S. Cl. CPC G07C 5/10; G01S 19/13; G01C 21/3453; G07C 5/006

(57) ABSTRACT

Embodiments herein relate to vehicle filter monitoring systems and methods. In an embodiment, a filter monitoring system is included having a filter sensor device configured to generate data reflecting a filter condition value of a filter and a geolocation circuit configured to determine a present geolocation of a vehicle. The system can also include a system control circuit configured to generate or receive local contaminant concentration values at the present geolocation, evaluate the filter sensor device data to determine at least one of the filter condition value and a change in the filter condition value, and generate at least one of a maintenance recommendation and a routing recommendation based on the local contaminant concentration values, time spent at the geolocation of the vehicle, duty cycle of the vehicle, the filter condition value, and a change in the filter condition value. Other embodiments are also included herein.

This application claims the benefit of U.S. Provisional Application No. 63/227,198, filed Jul. 29, 2021, the content of which is herein incorporated by reference in its entirety.

### FIELD

Embodiments herein relate to vehicle filter monitoring systems and methods.

### BACKGROUND

Filtration systems help maximize the useful service life of various vehicle components. As such, vehicles commonly include many different types of filtration systems including, but not limited to, cabin air filtration systems, engine air intake filtration systems, oil filtration systems, fuel filtration systems, coolant filtration systems, power steering filtration systems, crankcase lubrication filtration systems, transmission fluid filtration systems, and the like.

Filtration systems generally require periodic maintenance to replace filters at the end of their service life. Improper maintenance can risk damage and degradation of components and, in the case of air intake filters, can negatively impact fuel efficiency. In the case of fuel cells, improper maintenance can result in degradation of the fuel cell and reduced efficiency.

### SUMMARY

Embodiments herein relate to vehicle filter monitoring systems and methods. In a first aspect, a filter monitoring system can be included having a filter sensor device, wherein the filter sensor device can be configured to generate data reflecting a filter condition value of a filter, a geolocation circuit, wherein the geolocation circuit can be configured to determine a present geolocation of a vehicle, and a system control circuit. The system control circuit can be configured to generate or receive local contaminant concentration values at the present geolocation, evaluate the filter sensor device data to determine at least one of the filter condition value and a change in the filter condition value, and generate at least one of a maintenance recommendation and a routing recommendation based on the local contaminant concentration values, time spent at the geolocation of the vehicle, duty cycle of the vehicle, the filter condition value, and a change in the filter condition value.

In a second aspect, in addition to one or more of the preceding or following aspects, or in the alternative to some aspects, the system control circuit can be configured to generate or receive the local contaminant concentration values for past geolocations of the vehicle and durations of time spent at the same.

In a third aspect, in addition to one or more of the preceding or following aspects, or in the alternative to some aspects, the filter monitoring system can be an on-vehicle monitoring system.

In a fourth aspect, in addition to one or more of the preceding or following aspects, or in the alternative to some aspects, the filter condition value can include a filter restriction value.

In a fifth aspect, in addition to one or more of the preceding or following aspects, or in the alternative to some aspects, the filter sensor device can include at least one selected from the group consisting of a pressure sensor, an optical sensor, an aural sensor, an electrical property sensor, and a chemical sensor.

In a sixth aspect, in addition to one or more of the preceding or following aspects, or in the alternative to some aspects, the geolocation circuit can include a GPS receiver.

In a seventh aspect, in addition to one or more of the preceding or following aspects, or in the alternative to some aspects, the local contaminant concentration values can include airborne particulate concentration values.

In an eighth aspect, in addition to one or more of the preceding or following aspects, or in the alternative to some aspects, the airborne particulate can include smoke.

In a ninth aspect, in addition to one or more of the preceding or following aspects, or in the alternative to some aspects, the airborne particulate can include pollen.

In a tenth aspect, in addition to one or more of the preceding or following aspects, or in the alternative to some aspects, the airborne particulate can include agricultural harvest particulates.

In an eleventh aspect, in addition to one or more of the preceding or following aspects, or in the alternative to some aspects, the airborne particulate can include work site particulates.

In a twelfth aspect, in addition to one or more of the preceding or following aspects, or in the alternative to some aspects, the maintenance recommendation can include a filter change time recommendation.

In a thirteenth aspect, in addition to one or more of the preceding or following aspects, or in the alternative to some aspects, the maintenance recommendation can include a filter type recommendation.

In a fourteenth aspect, a vehicle fleet monitoring system can be included having a filter status monitor, wherein the filter status monitor can be configured to receive data reflecting a filter condition value of a filter of vehicles in a fleet, and a control circuit, wherein the control circuit can be configured to generate or receive local contaminant concentration values at geolocations visited by vehicles in the fleet, determine an impact on filter condition of time spent at the geolocations visited by vehicles in the fleet, and estimate and store a contaminant impact value of the geolocations visited by vehicles in the fleet.

In a fifteenth aspect, in addition to one or more of the preceding or following aspects, or in the alternative to some aspects, the control circuit can be configured to generate or receive local contaminant concentration values at geolocations visited by vehicles in the fleet and durations of time spent at the same.

In a sixteenth aspect, in addition to one or more of the preceding or following aspects, or in the alternative to some aspects, the filter condition value can include a filter restriction value.

In a seventeenth aspect, in addition to one or more of the preceding or following aspects, or in the alternative to some aspects, the local contaminant concentration values can include airborne particulate concentration values.

In an eighteenth aspect, in addition to one or more of the preceding or following aspects, or in the alternative to some aspects, the airborne particulate can include smoke.

In a nineteenth aspect, in addition to one or more of the preceding or following aspects, or in the alternative to some aspects, the airborne particulate can include pollen.

In a twentieth aspect, in addition to one or more of the preceding or following aspects, or in the alternative to some aspects, the airborne particulate can include agricultural harvest particulates.

In a twenty-first aspect, in addition to one or more of the preceding or following aspects, or in the alternative to some aspects, the airborne particulate can include work site particulates.

In a twenty-second aspect, in addition to one or more of the preceding or following aspects, or in the alternative to some aspects, the control circuit can be configured to determine a recommended vehicle route for an individual vehicle based in part on contaminant impact values of geolocations along possible routes.

In a twenty-third aspect, in addition to one or more of the preceding or following aspects, or in the alternative to some aspects, the control circuit can be configured to estimate a type of contaminant present at a geolocation based on the determined impact on filter condition of time spent at the geolocation.

In a twenty-fourth aspect, a filter monitoring system can be included having a filter sensor device, wherein the filter sensor device can be configured to generate data reflecting a filter condition value of a filter, a geolocation circuit, wherein the geolocation circuit can be configured to determine a geolocation of a vehicle, and a system control circuit, wherein the system control circuit can be configured to evaluate the filter sensor device data to determine at least one of the filter condition value and a change in the filter condition value, receive data relating to filter loading conditions at a plurality of geolocations, and generate a recommended vehicle route based on a starting geolocation, an ending geolocation, and the filter loading conditions at geolocations along possible routes between the starting geolocation and the ending geolocation.

In a twenty-fifth aspect, in addition to one or more of the preceding or following aspects, or in the alternative to some aspects, the system control circuit can be configured to receive data relating to fuel prices at a plurality of geolocations corresponding to refueling stations and calculate the vehicle route based on the starting geolocation, the ending geolocation, and the fuel prices at the refueling stations along possible routes between the starting geolocation and the ending geolocation.

In a twenty-sixth aspect, in addition to one or more of the preceding or following aspects, or in the alternative to some aspects, the filter monitoring system can be an on-vehicle monitoring system.

In a twenty-seventh aspect, in addition to one or more of the preceding or following aspects, or in the alternative to some aspects, the filter condition value can include a filter restriction value.

In a twenty-eighth aspect, in addition to one or more of the preceding or following aspects, or in the alternative to some aspects, the filter sensor device can include at least one selected from the group consisting of a pressure sensor, an optical sensor, an aural sensor, an electrical property sensor, and a chemical sensor.

In a twenty-ninth aspect, in addition to one or more of the preceding or following aspects, or in the alternative to some aspects, the geolocation circuit can include a GPS receiver.

In a thirtieth aspect, in addition to one or more of the preceding or following aspects, or in the alternative to some aspects, the recommended vehicle route reflects the lowest estimated cost of vehicle operation based on parameters evaluated by the system.

In a thirty-first aspect, a fleet monitoring system can be included having a filter status controller, wherein the filter status controller can be configured to receive data reflecting a filter condition value of a filter for vehicles in a fleet, and a control circuit, wherein the control circuit can be configured to generate or receive local contaminant concentration values at the geolocation of vehicles in the fleet, calculate expected filter condition values based on the local contaminant concentration values associated with each vehicle in the fleet, and compare expected filter condition values against actual filter condition values.

In a thirty-second aspect, in addition to one or more of the preceding or following aspects, or in the alternative to some aspects, the control circuit can be configured to generate or receive local contaminant concentration values for past geolocations visited by vehicles in the fleet and durations of time spent at the same.

In a thirty-third aspect, in addition to one or more of the preceding or following aspects, or in the alternative to some aspects, the control circuit can be configured to send information regarding differences between expected filter condition values and actual filter condition values to a fleet operator.

In a thirty-fourth aspect, in addition to one or more of the preceding or following aspects, or in the alternative to some aspects, the control circuit can be configured to schedule a maintenance visit for vehicles when the actual filter condition values can be less than expected filter condition values by at least a threshold amount.

In a thirty-fifth aspect, in addition to one or more of the preceding or following aspects, or in the alternative to some aspects, the filter condition value can include a filter restriction value.

In a thirty-sixth aspect, in addition to one or more of the preceding or following aspects, or in the alternative to some aspects, the local contaminant concentration values can include airborne particulate concentration values.

In a thirty-seventh aspect, in addition to one or more of the preceding or following aspects, or in the alternative to some aspects, the airborne particulate can include smoke.

In a thirty-eighth aspect, in addition to one or more of the preceding or following aspects, or in the alternative to some aspects, the airborne particulate can include pollen.

In a thirty-ninth aspect, in addition to one or more of the preceding or following aspects, or in the alternative to some aspects, the airborne particulate can include agricultural harvest particulates.

In a fortieth aspect, in addition to one or more of the preceding or following aspects, or in the alternative to some aspects, the airborne particulate can include work site particulates.

In a forty-first aspect, a filter monitoring system can be included having a filter sensor device, wherein the filter sensor device can be configured to generate data reflecting a filter condition value of a filter, and a system control circuit, wherein the system control circuit can be configured to generate or receive local contaminant concentration values at a geolocation zone, evaluate the filter sensor device data to determine at least one of the filter condition value and a change in the filter condition value, and generate routing recommendations around the geolocation zone if the local contaminant concentration values exceed a threshold value.

In a forty-second aspect, in addition to one or more of the preceding or following aspects, or in the alternative to some aspects, further can include a geolocation circuit, wherein the geolocation circuit can be configured to determine a present geolocation of a vehicle.

In a forty-third aspect, in addition to one or more of the preceding or following aspects, or in the alternative to some aspects, the geolocation circuit can include a GPS receiver.

In a forty-fourth aspect, in addition to one or more of the preceding or following aspects, or in the alternative to some aspects, the filter monitoring system can be an on-vehicle monitoring system.

In a forty-fifth aspect, in addition to one or more of the preceding or following aspects, or in the alternative to some aspects, the filter condition value can include a filter restriction value.

In a forty-sixth aspect, in addition to one or more of the preceding or following aspects, or in the alternative to some aspects, the filter sensor device can include at least one selected from the group consisting of a pressure sensor, an optical sensor, an aural sensor, an electrical property sensor, and a chemical sensor.

In a forty-seventh aspect, in addition to one or more of the preceding or following aspects, or in the alternative to some aspects, the local contaminant concentration values can include airborne particulate concentration values.

In a forty-eighth aspect, in addition to one or more of the preceding or following aspects, or in the alternative to some aspects, the airborne particulate can include smoke.

In a forty-ninth aspect, in addition to one or more of the preceding or following aspects, or in the alternative to some aspects, the airborne particulate can include pollen.

In a fiftieth aspect, in addition to one or more of the preceding or following aspects, or in the alternative to some aspects, the airborne particulate can include construction site particulates.

In a fifty-first aspect, in addition to one or more of the preceding or following aspects, or in the alternative to some aspects, the geolocation zone can include a mining site, a construction site, or an agricultural site.

In a fifty-second aspect, a vehicle cabin filter monitoring system can be included having a geolocation circuit, wherein the geolocation circuit can be configured to determine geolocations of a vehicle over time, and a system control circuit, wherein the system control circuit can be configured to generate or receive local contaminant concentration values at the geolocations visited by the vehicle, and generate a cabin filter maintenance recommendation based on local contaminant concentration values and time spent at the geolocations visited by the vehicle.

In a fifty-third aspect, in addition to one or more of the preceding or following aspects, or in the alternative to some aspects, the geolocation circuit can include a GPS receiver.

In a fifty-fourth aspect, in addition to one or more of the preceding or following aspects, or in the alternative to some aspects, the local contaminant concentration values can include airborne particulate concentration values.

In a fifty-fifth aspect, in addition to one or more of the preceding or following aspects, or in the alternative to some aspects, the airborne particulate can include smoke.

In a fifty-sixth aspect, in addition to one or more of the preceding or following aspects, or in the alternative to some aspects, the airborne particulate can include pollen.

In a fifty-seventh aspect, in addition to one or more of the preceding or following aspects, or in the alternative to some aspects, the airborne particulate can include agricultural harvest particulates.

In a fifty-eighth aspect, in addition to one or more of the preceding or following aspects, or in the alternative to some aspects, the airborne particulate can include work site particulates.

In a fifty-ninth aspect, in addition to one or more of the preceding or following aspects, or in the alternative to some aspects, the maintenance recommendation can include a filter change time recommendation.

In a sixtieth aspect, in addition to one or more of the preceding or following aspects, or in the alternative to some aspects, the maintenance recommendation can include a filter type recommendation.

In a sixty-first aspect, a filter monitoring system can be included having a filter sensor device, wherein the filter sensor device can be configured to generate data reflecting a filter condition value of a filter, a geolocation circuit, wherein the geolocation circuit can be configured to determine a present geolocation of a vehicle, and a system control circuit, wherein the system control circuit can be configured to generate or receive local contaminant concentration values at the present geolocation, evaluate the filter sensor device data to determine at least one of the filter condition value and a change in the filter condition value, and generate a filter recommendation based on local contaminant concentration values and the filter sensor device data.

In a sixty-second aspect, in addition to one or more of the preceding or following aspects, or in the alternative to some aspects, the system control circuit can be configured to generate or receive the local contaminant concentration values for past geolocations and durations spent at the same.

In a sixty-third aspect, in addition to one or more of the preceding or following aspects, or in the alternative to some aspects, the filter monitoring system can be an on-vehicle monitoring system.

In a sixty-fourth aspect, in addition to one or more of the preceding or following aspects, or in the alternative to some aspects, the filter condition value can include a filter restriction value.

In a sixty-fifth aspect, in addition to one or more of the preceding or following aspects, or in the alternative to some aspects, the filter sensor device can include at least one selected from the group consisting of a pressure sensor, an optical sensor, an aural sensor, an electrical property sensor, and a chemical sensor.

In a sixty-sixth aspect, in addition to one or more of the preceding or following aspects, or in the alternative to some aspects, the geolocation circuit can include a GPS receiver.

In a sixty-seventh aspect, in addition to one or more of the preceding or following aspects, or in the alternative to some aspects, the local contaminant concentration values can include airborne particulate concentration values.

In a sixty-eighth aspect, in addition to one or more of the preceding or following aspects, or in the alternative to some aspects, the airborne particulate can include smoke.

In a sixty-ninth aspect, in addition to one or more of the preceding or following aspects, or in the alternative to some aspects, the airborne particulate can include pollen.

In a seventieth aspect, in addition to one or more of the preceding or following aspects, or in the alternative to some aspects, the airborne particulate can include construction site particulates.

In a seventy-first aspect, in addition to one or more of the preceding or following aspects, or in the alternative to some aspects, the filter recommendation can include a filter change time recommendation.

In a seventy-second aspect, in addition to one or more of the preceding or following aspects, or in the alternative to some aspects, the filter recommendation can include a filter type recommendation.

In a seventy-third aspect, a vehicle fleet filtration maintenance system can be included having a control circuit, wherein the control circuit can be configured to generate or receive contaminant concentration values at future geolocations of fleet vehicles based on routing data, and direct distribution of filter maintenance products to vehicle maintenance sites based on the contaminant concentration values.

In a seventy-fourth aspect, in addition to one or more of the preceding or following aspects, or in the alternative to some aspects, the local contaminant concentration values can include airborne particulate concentration values.

In a seventy-fifth aspect, in addition to one or more of the preceding or following aspects, or in the alternative to some aspects, the airborne particulate can include smoke.

In a seventy-sixth aspect, in addition to one or more of the preceding or following aspects, or in the alternative to some aspects, the airborne particulate can include pollen.

In a seventy-seventh aspect, in addition to one or more of the preceding or following aspects, or in the alternative to some aspects, the airborne particulate can include agricultural harvest particulates.

In a seventy-eighth aspect, in addition to one or more of the preceding or following aspects, or in the alternative to some aspects, the airborne particulate can include work site particulates.

In a seventy-ninth aspect, in addition to one or more of the preceding or following aspects, or in the alternative to some aspects, the control circuit can be configured to direct a quantity of filter maintenance products to vehicle maintenance sites based on the contaminant concentration values.

In an eightieth aspect, in addition to one or more of the preceding or following aspects, or in the alternative to some aspects, the control circuit can be configured to direct a type of filter maintenance products to vehicle maintenance sites based on the contaminant concentration values.

In an eighty-first aspect, a vehicle fleet monitoring system can be included having a filter status controller, wherein the filter status controller can be configured to receive data reflecting a filter restriction value of a filter of each vehicle in a fleet, and a control circuit, wherein the control circuit can be configured to generate or receive local contaminant concentration values at the geolocation of each vehicle in the fleet, and generate a work order for filter maintenance for fleet vehicles based on local contaminant concentration values at each geolocation visited by the fleet vehicles and/or check inventory for a recommended filter and order or initiate an order for the same if not found in inventory.

In an eighty-second aspect, in addition to one or more of the preceding or following aspects, or in the alternative to some aspects, the work order can include a recommended filter type.

In an eighty-third aspect, in addition to one or more of the preceding or following aspects, or in the alternative to some aspects, the local contaminant concentration values can include airborne particulate concentration values.

In an eighty-fourth aspect, in addition to one or more of the preceding or following aspects, or in the alternative to some aspects, the airborne particulate can include smoke.

In an eighty-fifth aspect, in addition to one or more of the preceding or following aspects, or in the alternative to some aspects, the airborne particulate can include pollen.

In an eighty-sixth aspect, in addition to one or more of the preceding or following aspects, or in the alternative to some aspects, the airborne particulate can include agricultural harvest particulates.

In an eighty-seventh aspect, in addition to one or more of the preceding or following aspects, or in the alternative to some aspects, the airborne particulate can include work site particulates.

In an eighty-eighth aspect, in addition to one or more of the preceding or following aspects, or in the alternative to some aspects, the control circuit can be configured to send the work order for filter maintenance to a vehicle maintenance site along a route of the vehicle.

In an eighty-ninth aspect, a filter monitoring system can be included having a filter sensor device, wherein the filter sensor device can be configured to generate data reflecting a filter condition value of a filter, a geolocation circuit, wherein the geolocation circuit can be configured to determine a present geolocation of a vehicle, and a system control circuit, wherein the system control circuit can be configured to generate or receive contaminant conditions data associated with the present geolocation, evaluate the filter sensor device data to determine at least one of the filter condition value and a change in the filter condition value, and calculate an expected loading rate associated with vehicle presence in the present geolocation.

In a ninetieth aspect, in addition to one or more of the preceding or following aspects, or in the alternative to some aspects, the system control circuit can be configured to generate or receive contaminant conditions data at past geolocations and durations of time spent at the same.

In a ninety-first aspect, in addition to one or more of the preceding or following aspects, or in the alternative to some aspects, the filter monitoring system can be an on-vehicle monitoring system.

In a ninety-second aspect, in addition to one or more of the preceding or following aspects, or in the alternative to some aspects, the filter condition value can include a filter restriction value.

In a ninety-third aspect, in addition to one or more of the preceding or following aspects, or in the alternative to some aspects, the filter sensor device can include at least one selected from the group consisting of a pressure sensor, an optical sensor, an aural sensor, an electrical property sensor, and a chemical sensor.

In a ninety-fourth aspect, in addition to one or more of the preceding or following aspects, or in the alternative to some aspects, the geolocation circuit can include a GPS receiver.

In a ninety-fifth aspect, in addition to one or more of the preceding or following aspects, or in the alternative to some aspects, the contaminant conditions data can include airborne particulate concentration values.

In a ninety-sixth aspect, in addition to one or more of the preceding or following aspects, or in the alternative to some aspects, the airborne particulate can include smoke.

In a ninety-seventh aspect, in addition to one or more of the preceding or following aspects, or in the alternative to some aspects, the airborne particulate can include pollen.

In a ninety-eighth aspect, in addition to one or more of the preceding or following aspects, or in the alternative to some aspects, the airborne particulate can include construction site particulates.

In a ninety-ninth aspect, in addition to one or more of the preceding or following aspects, or in the alternative to some aspects, the system control circuit can be configured to generate a maintenance recommendation based the expected loading rate.

In a one hundredth aspect, in addition to one or more of the preceding or following aspects, or in the alternative to some aspects, the maintenance recommendation can include a filter change time recommendation.

In a one hundred and first aspect, in addition to one or more of the preceding or following aspects, or in the alternative to some aspects, the maintenance recommendation can include a filter type recommendation.

In a one hundred and second aspect, a filter monitoring system can be included having a filter sensor device, wherein the filter sensor device can be configured to generate data reflecting a filter condition value of a filter, a geolocation circuit, wherein the geolocation circuit can be configured to determine a present geolocation of a vehicle, and a system control circuit, wherein the system control circuit can be configured to evaluate the filter sensor device data to determine at least one of the filter condition value and a change in the filter condition value, and generate at least one of a maintenance recommendation and a routing recommendation based on the filter condition value and/or a change in the filter condition value.

In a one hundred and third aspect, in addition to one or more of the preceding or following aspects, or in the alternative to some aspects, the filter monitoring system can be an on-vehicle monitoring system.

In a one hundred and fourth aspect, in addition to one or more of the preceding or following aspects, or in the alternative to some aspects, the filter condition value can include a filter restriction value.

In a one hundred and fifth aspect, in addition to one or more of the preceding or following aspects, or in the alternative to some aspects, the filter sensor device can include at least one selected from the group consisting of a pressure sensor, an optical sensor, an aural sensor, an electrical property sensor, and a chemical sensor.

In a one hundred and sixth aspect, in addition to one or more of the preceding or following aspects, or in the alternative to some aspects, the geolocation circuit can include a GPS receiver. In a one hundred and seventh aspect, in addition to one or more of the preceding or following aspects, or in the alternative to some aspects, the maintenance recommendation can include a filter change time recommendation.

In a one hundred and eighth aspect, in addition to one or more of the preceding or following aspects, or in the alternative to some aspects, the maintenance recommendation can include a filter type recommendation.

This summary is an overview of some of the teachings of the present application and is not intended to be an exclusive or exhaustive treatment of the present subject matter. Further details are found in the detailed description and appended claims. Other aspects will be apparent to persons skilled in the art upon reading and understanding the following detailed description and viewing the drawings that form a part thereof, each of which is not to be taken in a limiting sense. The scope herein is defined by the appended claims and their legal equivalents.

### BRIEF DESCRIPTION OF THE FIGURES

Aspects may be more completely understood in connection with the following figures (FIGS.), in which:

FIG. 1 is a schematic view of components of a system in accordance with various embodiments herein.

FIG. 2 is a schematic view of an air filtration device in accordance with various embodiments herein.

FIG. 3 is a schematic view of an air filtration device and devices in communication with a filter monitoring system in accordance with various embodiments herein.

FIG. 4 is a schematic view of components of a system in accordance with various embodiments herein.

FIG. 5 is a graph illustrating normal and abnormal filter loading curves in accordance with various embodiments herein.

FIG. 6 is a schematic view of a vehicle travel area in accordance with various embodiments herein.

FIG. 7 is a diagram of costs associated with two different vehicle routes in accordance with various embodiments herein.

FIG. 8 is a schematic view of product distribution channels in accordance with various embodiments herein.

FIG. 9 is a schematic view of geolocating devices in accordance with various embodiments herein.

FIG. 10 is a block diagram of components of a filter monitoring system in accordance with various embodiments herein.

While embodiments are susceptible to various modifications and alternative forms, specifics thereof have been shown by way of example and drawings, and will be described in detail. It should be understood, however, that the scope herein is not limited to the particular aspects described. On the contrary, the intention is to cover modifications, equivalents, and alternatives falling within the spirit and scope herein.

### DETAILED DESCRIPTION

Failure to timely replace filters can risk damage and damage and degradation of vehicle/system components and, in the case of air intake filters or fuel cell filters, can negatively impact fuel efficiency. As such, it can be important to monitor the condition of filters so that they can be replaced as needed. Certain conditions can result in increased filter loading that may shorten the normal service life of a filter. For example, contaminants such as airborne particulates in high concentrations can lead to faster than normal loading of engine air intake filters.

Air usually contains a certain amount of solid matter that comes from both natural sources such as soil, wind-blown dust (aeolian processes), seasonal processes, and fires, as well as anthropic activities. Knowing the quantity and/or type of airborne particulates in the air can lead to more accurate filter service life predictions. Further, knowing the quantity and/or type of airborne particulates can lead to more accurate selections of the appropriate filter to use.

However, the concentrations and types of contaminants are not uniformly dispersed across large geospatial areas. Rather, local concentrations and types of contaminants can vary substantially based on the weather, drought conditions, wind currents, events such as forest fires, proximity to anthropic activities such as road construction work, and the like. This can make it difficult to accurately account for concentrations of contaminants across a large potential vehicle travel zone, particularly in the context of vehicles that may travel hundreds or thousands of miles as part of a route. However, in accordance with embodiments herein, geospatial patterns of contaminants, such as airborne particulates, can be identified and accounted for allowing for more accurate estimates of filter service life and more accurate selection of appropriate filter types. In various embodiments, a filter monitoring system herein can include a filter sensor device configured to generate data reflecting a filter condition value of a filter. The filter monitoring system herein can also include a geolocation circuit configured to determine a present geolocation of a vehicle. The filter monitoring system can also include system control circuit configured to generate or receive local contaminant concentration values at the geolocation of the vehicle, evaluate the filter sensor device data to determine at least one of the filter condition value and a change in the filter condition value, and generate at least one of a maintenance recommendation and a routing recommendation.

The maintenance recommendation and a routing recommendation can be based on the local contaminant concentration values, time spent at the geolocation of the vehicle, time spent at other geolocations previously with other contaminant concentrations, duty cycle of the vehicle, the filter condition value, and a change in the filter condition value. Maintenance recommendations can include, but are not limited to, a filter change time recommendation, and a filter type recommendation. Other embodiments herein can include other types of filter monitoring systems, vehicle fleet monitoring systems, and vehicle fleet filtration maintenance systems as described in greater detail below.

In various embodiments, the filter condition value can be a filter restriction value. In some embodiments, the filter restriction value can be a pressure-based value, such as a pressure drop or differential pressure across the filter. In various embodiments, the filter condition value can be a filter loading value. In various embodiments, the filter condition value can be a measure of remaining filter life. It will be appreciated that certain values, such as a filter restriction value, as measured at a discrete point in time will depend on a vehicle or system's operating state. For example, high flow rates will result in a high differential pressure and/or lower chemical efficiency. Embodiments herein can account for a vehicle or system's operating state by normalizing or adjusting filter restriction values or other filter condition values to correct for the vehicle or system's operating state. In some cases, normalization or adjustment can be performed using a standard curve. In some embodiments, the system herein can be configured to utilize peak values of filter restriction values. In some embodiments, the system herein can be configured to utilize averaged values of filter restriction values.

In various embodiments, filter monitoring systems herein can specifically be “on vehicle” filter monitoring systems. The term “vehicle” as used herein shall refer to any machine or device with an engine or motor that moves and burns or otherwise consumes fuel or energy. In other embodiments, filter monitoring systems herein can be “off vehicle”, or distributed with some components “on vehicle” and other components “off vehicle”.

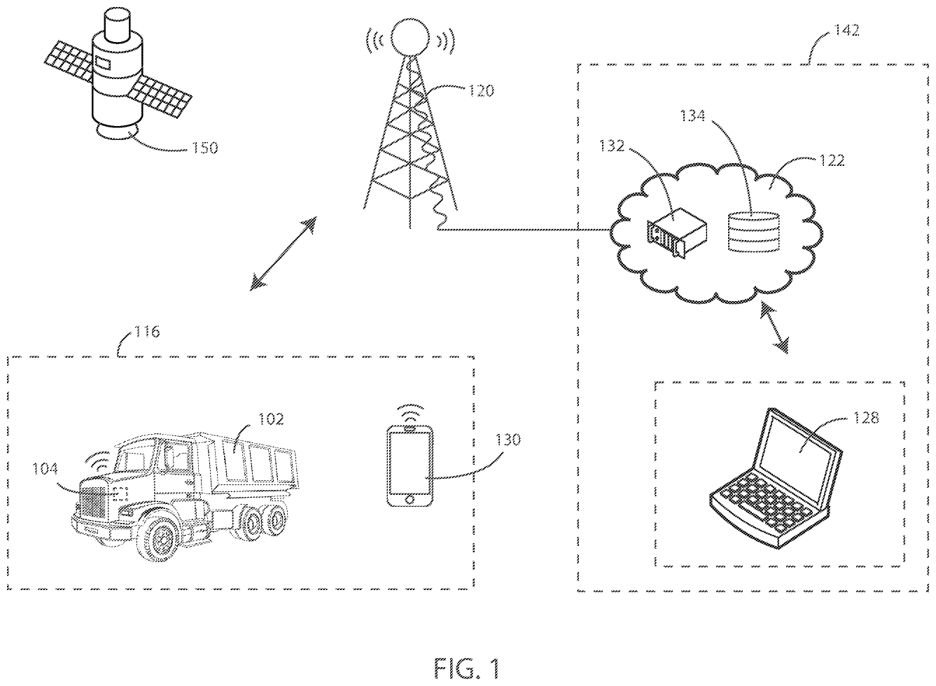

Referring now to FIG. 1, a schematic view of components of an exemplary system is shown in accordance with various embodiments herein. FIG. 1 shows a vehicle 102. The vehicle 102 includes a filter monitoring system 104. The vehicle 102 is depicted as being at a vehicle geolocation 116. The vehicle geolocation 116 can have a certain amount of contamination present, such as airborne particulates. The filter monitoring system 104 can generate and/or receive local contaminant concentration values at the vehicle geolocation 116. For example, in some embodiments, the filter monitoring system 104 can include one or more sensors (described in greater detail below) to provide data in order to derive information regarding local contaminant concentration values. In some embodiments, the filter monitoring system 104 can receive data regarding local contaminant concentration values either from another system or sensor on the vehicle or from a remote data source (such as a remote system or database) based on the current geolocation of the vehicle. In some embodiments, the filter monitoring system 104 can both derive information regarding local contaminant concentrations as well as receive information regarding the same from other sensors and/or systems. The filter monitoring system 104 can then perform various actions (as described in greater detail below) using the data regarding local contaminant concentration values.

In some cases, the filter monitoring system 104 can be capable of direct wireless data communication to the cloud 122 or to another data network. For example, in some cases, the filter monitoring system 104 can exchange data, such as providing the vehicle's geolocation and receiving data regarding local contaminant concentration values for the vehicle's geolocation by interfacing with the cloud 122 or another data network. In some cases, the filter monitoring system 104 can be capable of indirect wireless data communication to the cloud 122 or to another data network. In some embodiments, the filter monitoring system 104 can communicate with a cellular communications tower 120, which in turn can relay data communications back and forth with the cloud 122 and components thereof such as servers 132 (real or virtual) and databases 134 (real or virtual).

Wireless communication herein can take place using various protocols. For example, wireless communications/signals exchanged between the filter monitoring system 104 or components thereof and the cloud 122 (or between components of the filter monitoring system 104) can follow many different communication protocol standards and can be conducted through radiofrequency transmissions, inductively, magnetically, optically, or even through a wired connection in some embodiments. In some embodiments herein, IEEE 802.11 (e.g., WIFI®), BLUETOOTH® (e.g., BLE, BLUETOOTH® 4.2 or 5.0), ZIGBEE®, or a cellular transmission protocol/platform can be used such as CDMA, cdmaOne, CDMA2000, TDMA, GSM, IS-95, LTE, 5G, GPRS, EV-DO, EDGE, UMTS, HSDPA, HSUPA, HSPA+, TD-SCDMA, WiMAX, and the like. In various embodiments, a different standard or proprietary wireless communication protocol can also be used.

As referenced, cloud 122 resources may include databases 134 and/or APIs. Such databases 134 and/or APIs can store and/or be a source of various pieces of information including, but not limited to, local contaminant concentration values at various geolocations, information related to local contaminant concentration values such as locations of construction areas and locations of fires, weather information at various geolocations, such as wind direction, wind speed, precipitation, humidity, and the like, local contaminant types, vehicle maintenance site data including locations of the same, vehicle routing data, vehicle filter condition data, vehicle filter type data, fleet data, vehicle data, filtration system data, and the like.

It will be appreciated that database content may be distributed across many different physical systems, devices, and locations. Further, while not depicted in FIG. 1, it will be appreciated that database records can also be stored at the level of the filter monitoring system 104 itself. In various embodiments, the database 134 or portions thereof can be stored at a location remote from other components of the system, such as the filter monitoring system 104. In some embodiments, records or portions of the database can be stored across different physical locations and, in some embodiments, cached across different physical locations for ready access.

In some embodiments, a mobile communications device 130 can also be associated with the vehicle 102 or an operator thereof. In some cases, the mobile communications device 130 can be used to assist in conveying information to and from the filter monitoring system 104. In some embodiments, the mobile communications device 130 can be used to assist in determining the present geolocation of the vehicle. In some embodiments, the mobile communications device 130 can be used to aid in providing information and/or alerts to a vehicle operator and/or receiving inputs from the vehicle operator. However, in some embodiments a mobile communications device 130 is omitted.

Embodiments herein can also include vehicle fleet monitoring systems. In this regard, certain components shown in FIG. 1 can form parts of a vehicle fleet monitoring system 142. For example, server 132 (real or virtual) and database 143 (real or virtual) can form part of a cloud-based or remote vehicle fleet monitoring system 142 and can be interfaced with by a fleet operator, such as from an operator workstation 128. Vehicle fleets herein can include vehicles of the same type, vehicles of dissimilar types, vehicles owned or managed by common entity, vehicles owned or managed by multiple entities, a subset of equipped vehicles, all equipped vehicles, or the like.

In various embodiments, the filter monitoring system 104 can interface with geolocation equipment in order to determine geolocation of the vehicle. For example, in some embodiments, the filter monitoring system 104 can interface with a geolocation satellite 150 in order to provide geolocation coordinates. Other types of geolocation equipment are described in greater detail below.

As described above, the filter monitoring system can include a system control circuit configured to generate or receive local contaminant values and/or concentration values at the geolocation of the vehicle. In various embodiments, the local contaminant concentration values can include airborne particulate concentration values. In various embodiments, the local contaminant values can include airborne particulate types. Airborne particulates referred to herein are not particularly limited. However, by way of example, airborne particulates can include, but are not limited to, smoke, pollen, agricultural harvest particulates, work site particulates, and the like.

In some embodiments, the filter monitoring system 104 can specifically be a monitoring system for engine air filter systems. However, the filter monitoring system 104 can also be used for monitoring other types of fluid filtration systems including, for example, fuel filters, oil filters, power steering fluid filters, exhaust filters, cabin air filters, transmission filter, crankcase filters, and the like. As such, the type of vehicle filtration system is not particularly limited.

By way of example, in various embodiments herein, a vehicle cabin air filter monitoring system can specifically be included. The vehicle cabin air filter monitoring system can include a geolocation circuit configured to determine geolocations of a vehicle over time along with a system control circuit configured to generate or receive local contaminant concentration values at the geolocations visited by the vehicle and generate a cabin filter maintenance recommendation based on local contaminant concentration values and time spent at the geolocations visited by the vehicle.

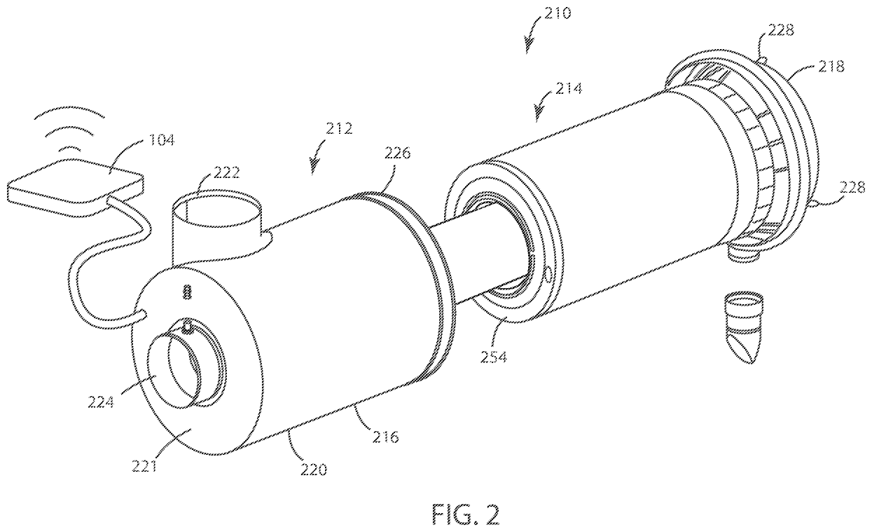

Referring now to FIG. 2, a schematic view of an air filtration system 210 is shown in accordance with various embodiments herein. The air filtration device 210 can interface with the filter monitoring system 104. In some embodiments, the air filtration device 210 and the filter monitoring system 104 can be physically integrated.

FIG. 2 specifically shows an exemplary air filtration system 210 including a filter housing and filter element in accordance with various embodiments herein. The air filtration system 210 depicted includes a housing 212 and a removable and replaceable primary filter element 214. In the one shown, the housing 212 includes a housing body 216 and a removable service cover 218. The cover 218 provides for service access to an interior of the housing body 216 for servicing. For a filtration system 210 of the general type depicted in FIG. 2, servicing generally involves dismounting and removing from the housing 212 at least one filter element, such as filter element 214 depicted, either for refurbishing or replacement.

The housing 212 depicted includes an outer wall 220 having an end 221, an air inlet 222, and an air outlet 224. For the embodiment depicted, the inlet 222 and the outlet 224 are both in the housing body 216. In other embodiments, at least one of the inlet 222 or outlet 224 can be part of the cover 218. In typical use, ambient or unfiltered air enters the filtration system 210 through the inlet 222. Within the filtration system 210, the air is passed through the filter element 214 to obtain a desirable level of particulate removal.

The filtered air then passes outwardly from the filtration system 210 through the outlet 224 and is directed by appropriate duct work or conduits to an inlet of an air intake for an associated engine, or compressor, or other system.

While FIG. 2 describes a filter element for particulate removal, it will be appreciated that embodiments herein can also including filter systems and/or filter elements for removal of gas phase and/or liquid phase contaminants.

The particular filtration system 210 depicted has outer wall 220 defining a barrel shape or generally cylindrical configuration. In this particular configuration, the outlet 224 can be described as an axial outlet because it generally extends in the direction of and circumscribes a longitudinal central axis defined by the filter element 214. The service cover 218 generally fits over an open end 226 of the housing body 216. In the particular arrangement shown, the cover 218 is secured in place over the end 226 by latches 228.

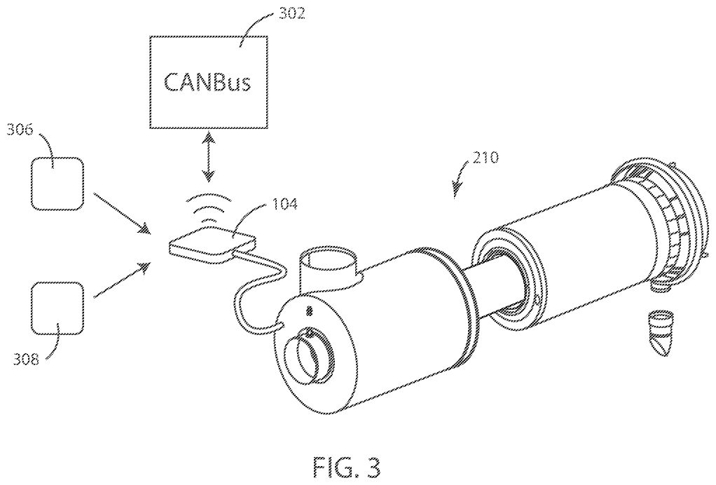

Referring now to FIG. 3, a schematic view is shown of an air filtration device 210 and devices in communication with a filter monitoring system 104 in accordance with various embodiments herein. The filter monitoring system 104 can interface with an air filtration system 210. The filter monitoring system 104 can also interface with a CANBus network on the vehicle to get various pieces of data regarding vehicle operation. The filter monitoring system 104 can also interface with a contaminant sensor 306 and/or a particulate sensor 308. Contaminant sensor 306 and particulate sensor 308 can be based on various sensing principles including, but not limited to, optical, acoustic, electrical, weight, and/or pressure principles in order to detect contaminants.

Particulate sensors herein (which can be part of the filter monitoring system 104 and/or can be separate, but interface with the filter monitoring system 104) can include, but are not limited to, aerosol particle sensors, solid particle sensors, liquid particle sensors, and the like. Particulate sensors are sometimes referred to as particulate matter (PM) sensors. Some exemplary particle sensors can be based on light scatters, light obscuration, Coulter principle sensing, and/or direct imaging. Some exemplary particle sensors can include infrared optical particle sensors, beta attenuation mass monitoring sensors, laser diffraction sensors, and the like. Exemplary particulate sensors are described in U.S. Pat. Nos. 6,971,258; 7,275,415; 9,874,509; 10,006,883; and 10,330,579, the content of which related to particulate sensors is herein incorporated by reference in its entirety.

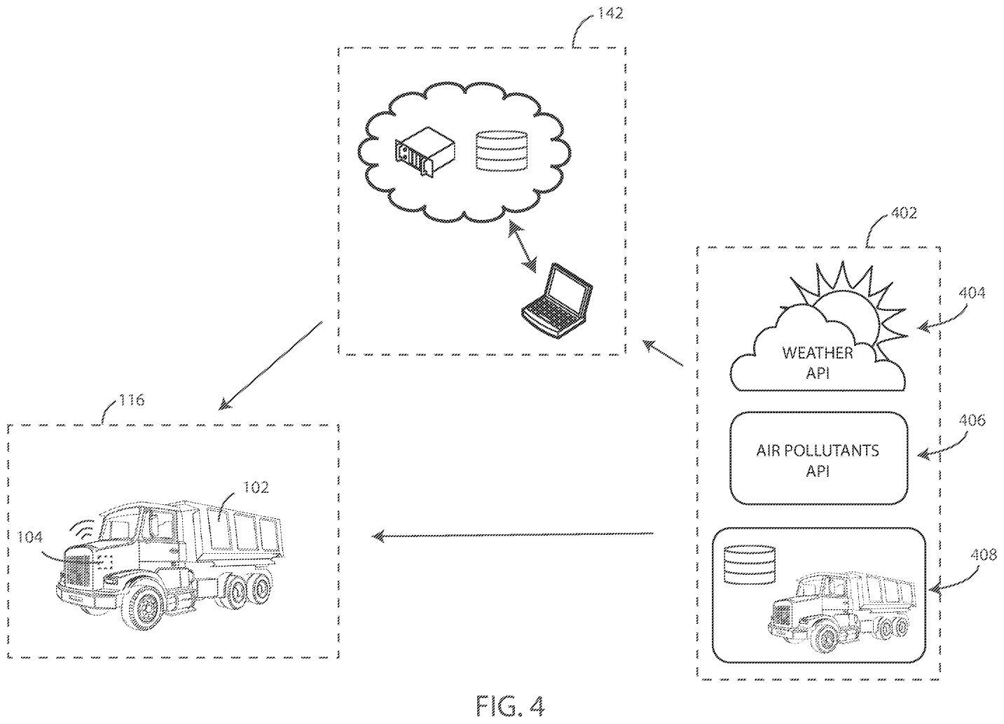

Contaminant/particulate data can be derived and/or received from various sources. Referring now to FIG. 4, a schematic view is shown of components of a system in accordance with various embodiments herein. Similar to as shown in FIG. 1, FIG. 4 shows a vehicle 102 with a filter monitoring system 104 at a vehicle geolocation 116. FIG. 4 also shows a vehicle fleet monitoring system 142 along with contaminant information sources 402. The contaminant information sources 402 can include a weather API 404, an air pollutants API 406, and a database 408 of geolocation indexed contaminant information. Weather API 404 data can include, but is not limited to, data regarding past, current, and/or future, temperature, humidity, precipitation, wind speed, wind direction, ambient pressure, cloud cover, and the like. Air pollutants API 406 data can include, but is not limited to, past, current, and/or future data regarding CO, NO, NO₂, O₃, SO₂, NH₃, PM2.5, PM10, pollen and the like.

The database 408 can be built and/or maintained in accordance with various embodiments herein. For example, in various embodiments, the vehicle and/or components thereof such as the filter monitoring system can detect contaminant concentrations either directly (such as through a sensor) or indirectly (such as through detection of an abnormal filter loading rate). For example, an abnormally fast filter loading rate observed with one or more vehicles in a particular geolocation can be inferred to be caused by contaminant concentrations within the geolocation and can be reported back the system maintaining the database accordingly.

Information regarding contaminant concentrations can be sent, along with geolocation data of the vehicle, on to a remote system which can process the data and store the same in the database 408. In some cases, an entire fleet of vehicles can report contaminant concentration data for storage in this way. In some cases, multiple fleets of vehicles can report contaminant concentration data for storage in this way allowing for the database 408 to be updated more often and therefore be more accurate regarding local conditions.

In various embodiments, the type of vehicle and its operational state can be a source of information on expected contamination levels and types. For example, if it is known that a vehicle type is one associated with road construction and its operational state is consistent with active use, then it can be inferred that the expected contaminant levels and types will be characteristic of those found in road construction areas during active use of the vehicle. This information can be used to more accurately characterize both the concentrations and types of contaminants. In addition, this information can be used to establish expected loading curve values for individual vehicles herein, such that abnormal filter loading conditions can be more accurately identified. Information regarding the type of vehicle and its operational state can be sent on to a remote system so that the same can be utilized in updating the database and/or in assessing local contaminant concentrations and types by the system.

In various embodiments, a vehicle fleet monitoring system can be included herein. The vehicle fleet monitoring system can include a filter status monitor configured to receive data reflecting a filter condition value of a filter of vehicles in a fleet. The vehicle fleet monitoring system can also include a control circuit configured to generate or receive local contaminant concentration values at geolocations visited by vehicles in the fleet, determine an impact on filter condition of time spent at the geolocations visited by vehicles in the fleet, and estimate and store a contaminant impact value of the geolocations visited by vehicles in the fleet. As an example, the contaminant impact value (and/or raw contaminant concentration data) can be stored in the database 408.

In various embodiments, a fleet monitoring system can include a filter status monitor or controller configured to receive data reflecting a filter condition value of a filter for vehicles in a fleet. The filter status controller can include data interface features to exchange data with vehicles and/or filter monitoring systems thereof In some embodiments, the filter status controller can implement an application programming interface (API) in order to allow structured data exchange with vehicles and/or filter monitoring systems thereof.

The fleet monitoring system can also include a control circuit configured to generate or receive local contaminant concentration values at the geolocation of vehicles in the fleet, calculate expected filter condition values based on the local contaminant concentration values associated with each vehicle in the fleet, and compare expected filter condition values against actual filter condition values. In some embodiments, the control circuit of the fleet monitoring system can include one or more microprocessors, microcontrollers, ASICs (application specific integrated circuits), or other processing devices. In some embodiments, the control circuit of the fleet monitoring system can integrated into a server (real or virtual).

The system can also take various actions based on the actual filter condition values observed. For example, in various embodiments, the control circuit can be configured to send information regarding differences between expected filter condition values and actual filter condition values to a fleet operator or issue a notification regarding the same. In various embodiments, the control circuit can be configured to schedule a maintenance visit for vehicles when the actual filter condition values are less than expected filter condition values by at least a threshold amount. In some embodiments, scheduling a maintenance visit can also include creating a work order for vehicle maintenance. The work order can include various pieces of information including, for example, one or more of a filter type, the identity of the vehicle, an expected service visit day and time, and the like.

Filter recommendations can be made in accordance with various embodiments herein. As an example, a filter monitoring system can include a filter sensor device configured to generate data reflecting a filter condition value of a filter. The filter monitoring system can also include a geolocation circuit configured to determine a present geolocation of a vehicle. The filter monitoring system can also include a system control circuit configured to generate or receive local contaminant concentration values at the present geolocation, evaluate the filter sensor device data to determine at least one of the filter condition value and a change in the filter condition value, and generate a filter recommendation based on local contaminant concentration values and the filter sensor device data.

Filter loading rates can be observed by embodiments herein and can be usefully applied. A higher-than-normal filter loading rate can be indicative of an increased concentration of contaminants such as airborne particulates in the geolocation of the vehicle. Thus, observation of a higher-than-normal filter loading rate at a particular geolocation can be used as a proxy for the contaminant concentration at that particular geolocation.

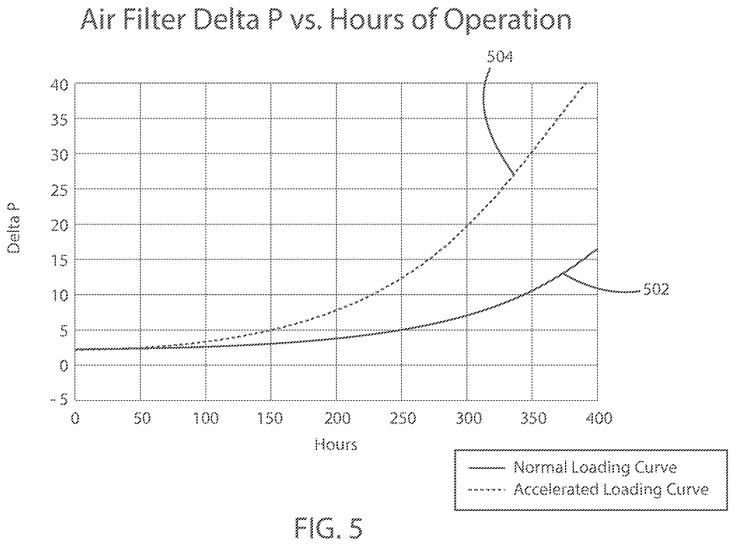

Referring now to FIG. 5, a graph illustrating normal and abnormal filter loading curves is shown in accordance with various embodiments herein. In specific, FIG. 5 shows a normal loading curve 502 along with an accelerated loading curve 504. In some embodiments, a loading curve can be deemed abnormal if it reflects loading at a rate that is greater than typically observed under similar circumstances. In some embodiments, a loading curve can be deemed abnormal if the rate of change exceeds a threshold value. In some embodiments, a loading curve can be deemed abnormal if the rate of change deviates from a baseline or default value by more than 5, 10, 15, 20, 25, 30, 40, 50, 75, or 100 percent, or an amount falling within a range between any of the foregoing.

In some cases, an empirically determined loading curve can be compared to an expected loading curve. Expected loading curves can be generated by starting with a base or default loading curve specific for a particular filter and then changing it based on information such as contaminants such as airborne particulates in the geolocation of the vehicle. For example, if the concentration of contaminants is higher than normal, a faster than normal loading curve would be expected. In some scenarios, a typical level of airborne fine particulate matter can be about 8.15 (μg/m³). However, for some embodiments herein, a normal level of particulates can be treated to be 5, 6, 7, 8, 9, 10, 11, 12 or higher (μg/m³). In other embodiments, a normal level of particulates can be significantly higher. In various embodiments, levels of particulates exceeding 10, 15, 20, 30, 50, 100, 250, 500, 1,000, 2,500, 5,000, 7,500, 10,000 μg/m³ can be treated as abnormally high levels of particulates, depending on the application. It will be appreciated, though, that concentrations of significance can vary depending on the specific type of contaminant, the type of vehicle, the type of filter, and the conditions of us. As merely one example, dust or soot at equivalent concentrations may load a given filter differently. In some embodiments, PM2.5 values can be used by the system as a proxy for soot particle concentrations (true soot concentration will typically be much lower than PM2.5). PM2.5 is defined as the concentration of suspended particles measuring less than 2.5 microns in diameter. In some embodiments, concentrations of particulates can be measured in accordance with U.S. 40 C.F.R. § 50, Appendix B, which provides a measurement of the mass concentration of total suspended particulate matter (TSP) in ambient air.

In various embodiments, the control circuit can be configured to estimate a type of contaminant present at a geolocation based on the determined impact on filter condition of time spent at the geolocation and/or information such as an observed loading curve. Different types of contaminants may result in different types of characteristic loading curves. As such, contaminant type can be determined by applying pattern matching techniques to determine the best match for an observed loading curve against a plurality of predetermined patterns that are characteristic of different types of contaminants. For example, the system can store loading curves (as standards or templates) associated with high smoke levels, high wind-blown dust levels, high mining site particulates, high soot levels, and the like. By matching observed loading curves against such standards or templates, the type of airborne particulates can be identified.

Exemplary pattern matching techniques are described in greater detail below, but can include methods such as Gaussian mixture models, clustering as well as Bayesian approaches, hidden Markov models, machine learning approaches such as neural network models and deep learning, and the like. Binary classification approaches can utilize techniques including, but not limited to, logistic regression, k-nearest neighbors, decision trees, support vector machine approaches, naive Bayes techniques, and the like. Multi-class classification approaches (e.g., for non-binary classifications of gait) can include k-nearest neighbors, decision trees, naive Bayes approaches, random forest approaches, and gradient boosting approaches amongst others. Similarity and dissimilarity of patterns can be measured directly via standard statistical metrics such normalized Z-score, or similar multidimensional distance measures (e.g., Mahalanobis or Bhattacharyya distance metrics), or through similarities of modeled data and machine learning.

Calculating an expected loading rate associated with vehicle presence in a particular geolocation can be valuable for estimating remaining service life of a filter. In various embodiments, a filter monitoring system herein can make such a calculation and can specifically include a filter sensor device configured to generate data reflecting a filter condition value of a filter and a geolocation circuit configured to determine a present geolocation of a vehicle. The filter monitoring system can also include a system control circuit configured to generate or receive contaminant conditions data associated with the present geolocation, evaluate the filter sensor device data to determine at least one of the filter condition value and a change in the filter condition value, and calculate an expected loading rate associated with vehicle presence in the present geolocation.

In various embodiments, the system control circuit can be configured to generate a maintenance recommendation based the expected loading rate. In various embodiments, the maintenance recommendation can include a filter change time recommendation. In various embodiments, the maintenance recommendation can include a filter type recommendation.

It will be appreciated that contaminants such as airborne particulates can be at different levels in different geolocations and can be generated through different mechanisms. For example, particulates resulting from a fire can be generated in a particular area and then, typically, can carried by wind currents resulting in an extended area over which smoke and other particulates can be found. A forest fire may result in smoke spread out over potentially hundreds of square miles. However, other scenarios may result in a much smaller area of contaminant dispersal. As such, in various embodiments herein, the system can account for weather information such as wind direction and wind speeds to account for where contaminants are likely to be encountered based on a circumstance such as a fire or other particulate generating event.

A dusty construction site with substantial earth moving equipment may also result in an area of relatively high airborne particulates, but typically not nearly as large as with a forest fire. In some embodiments, a weather event such as precipitation may temporarily reduce the amount of particulates associated with a construction site or another source of particulates in the air. As such, in some embodiments, systems herein can use information regarding potentially mitigating circumstances, such as precipitation when determining the impact of time spent in an area with significant particulates such as at a construction site or other work site.

In some cases, natural events, such as plants producing pollen at certain times of the year may result in an area with higher-than-normal airborne particulates. In some cases, weather events such as those involving high winds can result in an area of relatively high airborne contaminants such as particulates.

In some circumstances, a particular geolocation may have significantly different levels of airborne contaminants at different times of the day. For example, a construction site or work site may have significantly lower levels of airborne contaminants at times of the day when activity is reduced, such as during the night. In various embodiments herein, the system can account for the time of day when at a particular geolocation in calculations herein. In various embodiments herein, the system can store and/or utilize records of time spent at particular geolocations that include the time of day. In some embodiments, the system can value time spent at a geolocation during hours without significant contaminant loads at a lower amount. In some embodiments, such time can be valued (for purposes of contaminant loads) at a percentage of the amount of time spent with high amounts of airborne contaminants. In some embodiments, sensors herein or another source of data such as an API can be used to get airborne contaminants values at a particular time.

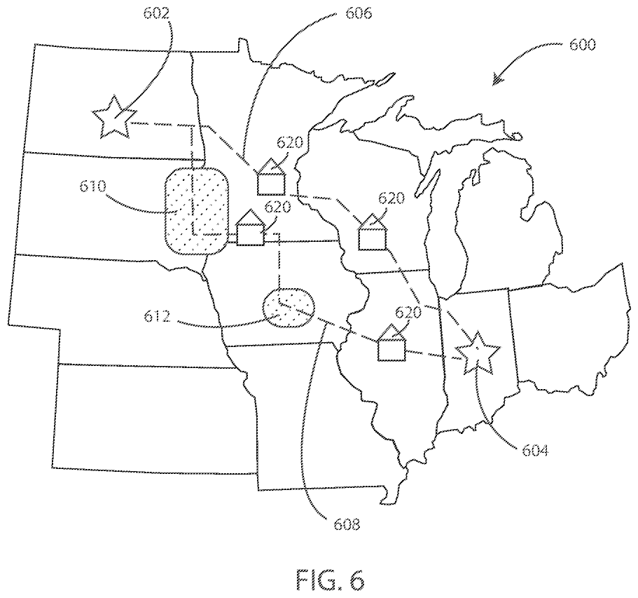

Referring now to FIG. 6, a schematic view of a vehicle travel area 600 is shown in accordance with various embodiments herein. The vehicle travel area 600 includes a starting geolocation 602 and an ending geolocation 604. The vehicle travel area 600 shows a first route 606 and a second route 608 between the starting geolocation 602 and the ending geolocation 604. The vehicle travel area 600 also includes an airborne particulate zone 610. As an example, the airborne particulate zone 610 may result from a forest or grass fire. The vehicle travel area 600 also includes an airborne particulate site 612. As an example, the airborne particulate site 612 may result from an area of road construction. The vehicle travel area 600 also includes several vehicle maintenance sites 620.

In various embodiments, the control circuit can be configured to determine a recommended vehicle 102 route for an individual vehicle 102 based in part on contaminant impact values of geolocations along possible routes. In particular, systems herein can provide route recommendations in view of various parameters including one or more of contaminant levels (such as airborne particulates) at geolocations along possible routes, distance traveled, time required for travel (speed), availability of maintenance sites along the route, and the like. This can be performed in various ways. As merely one example, based on a given starting point and a destination, possible routes can be identified using various techniques including utilizing an API such as the “Directions API” commercially available as part of the Google Maps Platform. For each route, geolocations along the same can be evaluated for levels of contaminants therein. In so doing, the optimal route from the perspective of filter loading can be identified. However, other factors can also be included/considered when calculating the optimal route including, but not limited to, distance travelled, time required for travel (speed), weather, availability of maintenance sites, availability of parts, price of fuel at refueling locations along the route, etc.

As an example regarding routing, in various embodiments herein a filter monitoring system herein can include a filter sensor device configured to generate data reflecting a filter condition value of a filter. The filter monitoring system can also include a geolocation circuit configured to determine a geolocation of a vehicle. The filter monitoring system can also include a system control circuit configured to evaluate the filter sensor device data to determine at least one of the filter condition value and a change in the filter condition value, receive data relating to filter loading conditions at a plurality of geolocations, and generate a recommended vehicle route based, at least in part, on a starting geolocation, an ending geolocation, and the filter loading conditions at geolocations along possible routes between the starting geolocation and the ending geolocation. In various embodiments, the system control circuit can be configured to receive data relating to the availability and/or cost of replacement filters along a route. For example, a given route may only be recommended if it includes the availability of replacement filters and/or if the cost of taking the route is optimized including the cost of replacement filters. It will be appreciated, however, that many other factors can also be considered in optimizing routes to minimize costs herein.

In various embodiments, the system control circuit can be configured to receive data relating to fuel prices at a plurality of geolocations corresponding to refueling stations and calculate the vehicle route based on the starting geolocation, the ending geolocation, and also considering the fuel prices at the refueling stations along possible routes, along with contaminant levels such as airborne particulates, between the starting geolocation and the ending geolocation.

In some embodiments, particular sites or zones can be avoided entirely. In various embodiments, a filter monitoring system herein can include a filter sensor device configured to generate data reflecting a filter condition value of a filter along with a system control circuit configured to generate or receive local contaminant concentration values at a geolocation zone, evaluate the filter sensor device data to determine at least one of the filter condition value and a change in the filter condition value, and generate routing recommendations around a geolocation zone if the local contaminant concentration values within the geolocation zone exceed a threshold value.

Information regarding particulates along vehicle routes can allow for proactive determination of when service might be required and/or actions to make service visits faster and/or more efficient. For example, in some embodiments, a work order can be automatically generated by the system in order to speed the process of obtaining vehicle maintenance work when needed.

As an example of this, in various embodiments, a vehicle fleet monitoring system can include a filter status controller configured to receive data reflecting a filter restriction value of a filter of each vehicle in a fleet. The vehicle fleet monitoring system can also include a control circuit configured to generate or receive local contaminant concentration values at the geolocation of each vehicle in the fleet and generate a work order for filter maintenance for fleet vehicles based on local contaminant concentration values at each geolocation visited by the fleet vehicles. In various embodiments, the work order can include a recommended filter type.

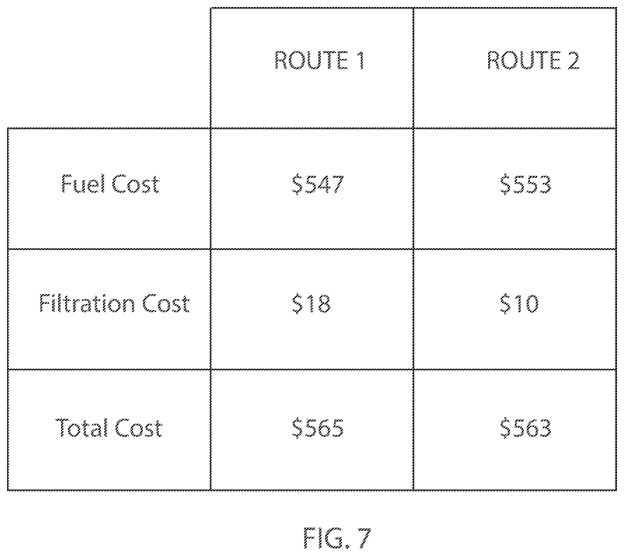

In various embodiments, a recommended vehicle route provided by the system reflects the lowest estimated cost of vehicle operation. Referring now to FIG. 7, a diagram of costs associated with two different vehicle 102 routes is shown in accordance with various embodiments herein. In this case, if only fuel prices are considered, then route 1 may appear to be best. However, when considering the impact of contaminants such as airborne particulates, then route 2 is determined to be the best. As such, in this scenario, the system can recommend route 2.

In can be important to ensure that proper inventory of parts necessary for vehicle service (such as replacement filters) is available when service is needed. Knowledge of contaminant levels, such as airborne particulates, can be useful when determining proper inventory levels. For example, if a particular area has a relatively high level of contaminants, it can be predicted that this will lead to accelerated filter loading and more required maintenance events at vehicle service sites on routes where vehicles will pass after traveling through the area of higher particulates. As such, it can be beneficial to provide more inventory to such vehicle service sites to ensure they have the proper replacement parts available when needed.

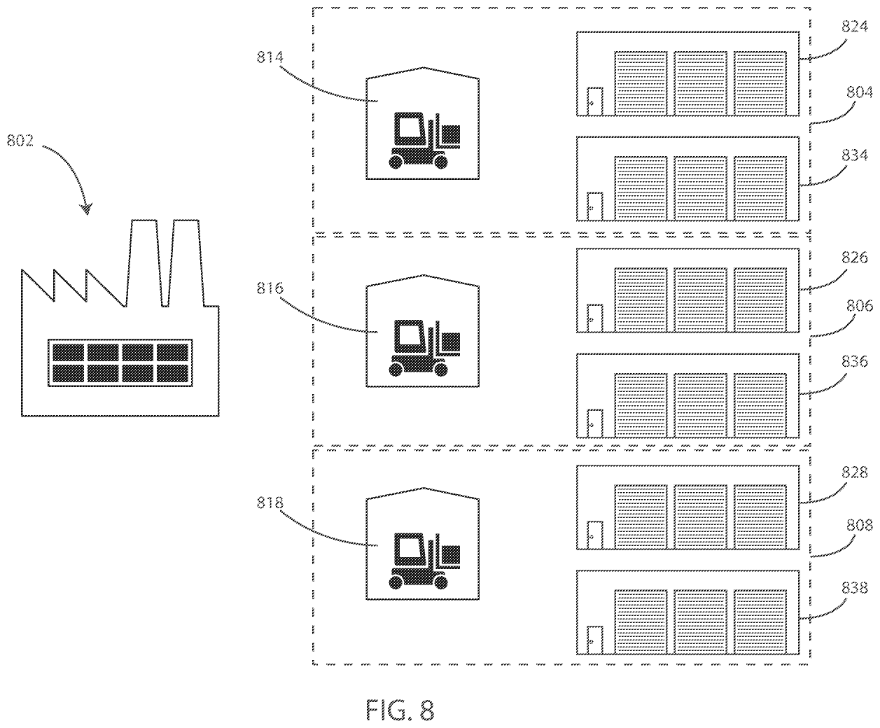

Referring now to FIG. 8, a schematic view of product distribution channels is shown in accordance with various embodiments herein. FIG. 8 shows a factory 802, which can be a source of parts needed for vehicle service, such as replacement filters. Such parts can be shipped into different distribution zones. In this regard, FIG. 8 shows a first distribution zone 804, a second distribution zone 806, and a third distribution zone 808. A first distribution site 814 and a first and second vehicle maintenance sites 824, 834 can be found within the first distribution zone 804. Similarly, the second distribution zone 806 includes a second distribution site 816, along with a third vehicle maintenance site 826 and a fourth vehicle maintenance site 836. The third distribution zone 808 includes a third distribution site 818 along with a fifth vehicle maintenance site 828 and a sixth vehicle maintenance site 838.

To the extent that the first distribution zone 804 has a greater number of geolocations therein with high levels of contaminants such as airborne particulates, then a greater amount of inventory can be directed to the first distribution zone 804 anticipating that more vehicles will stop at vehicle maintenance sites therein. Similarly, to the extent that the first distribution zone 804 has a greater number of geolocations therein with a particular type of contaminant therein, such as airborne particulates, then filter inventory of the type most appropriate for the particular type of contaminant can be directed to the first distribution zone 804.

In various embodiments herein, a vehicle fleet filtration maintenance system can include a control circuit configured to generate or receive contaminant concentration values at future geolocations of fleet vehicles based on routing data, and direct distribution of filter maintenance products to vehicle maintenance sites based on the contaminant concentration values. For example, the control circuit can be configured to direct a quantity of filter maintenance products to vehicle maintenance sites based on the contaminant concentration values. Further, the control circuit can be configured to direct a type of filter maintenance products to vehicle maintenance sites based on the contaminant concentration values.

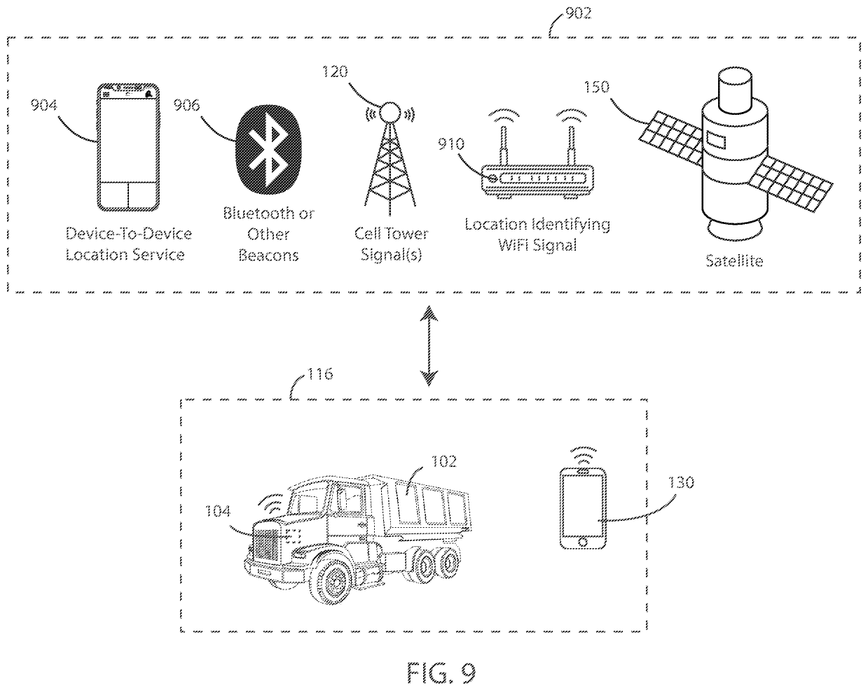

Geolocation can be determined in a number of different ways. In some embodiments, geolocation can be determined through interfacing with a geolocation device. Referring now to FIG. 9, a schematic view of geolocating equipment 902 is shown interfacing with a vehicle 102 including a filter monitoring system 104 at a vehicle geolocation 116. The geolocation equipment 902 can include a referential device 904, such as to be used in device-to-device geolocation determination. The geolocation equipment 902 can also include a beacon 906, such as a BLUETOOTH or other wireless communication geolocation beacon. The geolocation equipment 902 can also include a cellular communications tower 120. The geolocation equipment 902 can also include a router or other WIFI device 910. The geolocation equipment 902 can also include a geolocation satellite 150.

FIG. 9 also shows a mobile communications device 130, which can be used to aid in determining geolocation. In some embodiments, the mobile communications device 130 can itself determine geolocation and then convey this information to the filter monitoring system.

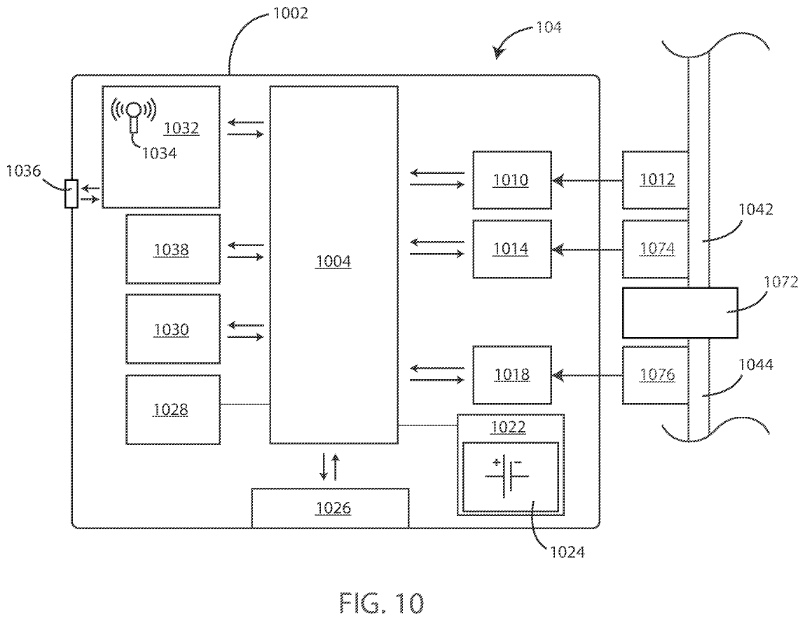

It will be appreciated that systems herein can include many different components. Referring now to FIG. 10, a block diagram is shown of some components of a filter monitoring system 104 in accordance with various embodiments herein. However, it will be appreciated that a greater or lesser number of components can be included with various embodiments and that this schematic diagram is merely illustrative.

In specific, FIG. 10 shows a filter monitoring system 104. The filter monitoring system 104 can include a housing 1002 and a system control circuit 1004 or (“control circuit”). The control circuit 1004 can include various electronic components including, but not limited to, a microprocessor, a microcontroller, a FPGA (field programmable gate array) chip, an application specific integrated circuit (ASIC), or the like. The control circuit 1004 can execute various operations as described herein. However, it will be appreciated that operations herein can be executed across multiple devices with separate physical circuits, processors, or controllers with different operations being performed redundantly or divided across different physical devices. As such, some operations may be performed (in whole or in part) at the edge, such as by a circuit/processor/controller associated with a filter monitoring system 104 while other operations may be performed (in whole or in part) by a separate device or in the cloud.

A filter sensor device can include an upstream pressure sensor 1074 that can be associated with an upstream portion of an air flow line 1042 and can be positioned upstream of the filter housing 1072 and/or as a part of the filter housing 1072, but upstream of the filter in the filter housing 1072. The upstream pressure sensor 204 can be in communication with an upstream pressure sensor channel interface 1014. The filter sensor device can also include a downstream pressure sensor 1076 that can be associated with a downstream portion of the air flow line 1044 and can be positioned downstream of the filter housing 1072 and/or as a part of the filter housing 1072, but downstream of the filter within the housing. The downstream pressure sensor 1076 can be in communication with a downstream pressure sensor channel interface 1018.

In various embodiments, the filter monitoring system 104 can include and/or be in communication with another type of sensor, such as particulate sensor 1012 and a particulate sensor channel interface 1010. Particulate sensors 1012 herein can operate according to various principles including pressure-based particulate sensors, optical particulate sensors, acoustic particulate sensor, electrical property-based particulate sensors, and the like. Other types of sensors herein can include vibration sensors, flow sensors, chemical concentration sensors, and the like.

The channel interfaces can include various components such as amplifiers, analog-to-digital converters (ADCs), digital-to-analog converters (DACs), digital signal processors (DSPs), filters (high-pass, low-pass, band-pass) and the like. In some cases, the channel interfaces may not exist as discrete components but, rather, can be integrated into the control circuit 1004.

In some embodiments, a temperature sensor can be included herein. Temperature sensors herein, where used, can be of various types. In some embodiments, the temperature sensor can be a thermistor, a resistance temperature device (RTD), a thermocouple, a semiconductor temperature sensor, or the like.

Pressure sensors herein can be of various types. The pressure sensors 204, 206 can include, but are not limited to, strain gauge type pressure sensors, capacitive type pressure sensors, piezoelectric type pressure sensors, and the like. In some embodiments, pressure sensors herein can be MEMS-based pressure sensors. In various embodiments, the pressure sensor can be a high-speed (e.g., high sample rate) pressure sensor. In various embodiments the high-speed pressure sensor can sample at rates of 1,000, 1,500, 2,000, 2,500, 3,000, 5,000, 10,000, 15,000, 20,000 Hz or higher, or at a rate falling within a range between any of the foregoing. In various embodiments the high-speed pressure sensor can have a response time of less than 10, 5, 2.5, 1, 0.5, 0.25, 0.1, 0.05 or 0.01 milliseconds, or a response time falling within a range between any of the foregoing.

The processing power of the control circuit 1004 and components thereof can be sufficient to perform various operations including various operations on signals/data from sensors including, but not limited to averaging, time-averaging, statistical analysis, normalizing, aggregating, sorting, deleting, traversing, transforming, condensing (such as eliminating selected data and/or converting the data to a less granular form), compressing (such as using a compression algorithm), merging, inserting, time-stamping, filtering, discarding outliers, calculating trends and trendlines (linear, logarithmic, polynomial, power, exponential, moving average, etc.), normalizing data/signals, and the like. Fourier analysis can decompose a physical signal into a number of discrete frequencies, or a spectrum of frequencies over a continuous range. In various embodiments herein, operations on signals/data can include Fast Fourier Transformations (FFT) to convert data/signals from a time domain to a frequency domain. Other operations on signals/data here can include spectral estimation, frequency domain analysis, calculation of root mean square acceleration value (GRMS), calculation of acceleration spectral density, power spectral densities, Fourier series, Z transforms, resonant frequency determination, harmonic frequency determination, and the like. It will be appreciated that while various of the operations described herein (such as Fast Fourier transforms) can be performed by general-purpose microprocessors, they can also be performed more efficiently by digital signal processors (DSPs) which can, in some embodiments, be integrated with the control circuit 1004 or may exist as separate, discrete components.

In various embodiments herein, machine learning algorithms can be used to derive the relationship between contaminant concentration values at specific geolocations and effects on filter loading behavior. Also, in various embodiments herein, machine learning algorithms can be used to match an observed filter loading curve against previously stored filter loading curves (such as pattern matching against archetype curves) in order to identify the type of loading curve that is observed and/or predict the future effects of such a curve. Machine learning algorithms used herein can include, but are not limited to, supervised learning and unsupervised learning algorithms.

Machine learning algorithms used herein can include, but are not limited to, classification algorithms (supervised algorithms predicting categorical labels), clustering algorithms (unsupervised algorithms predicting categorical labels), ensemble learning algorithms (supervised meta-algorithms for combining multiple learning algorithms together), general algorithms for predicting arbitrarily-structured sets of labels, multilinear subspace learning algorithms (predicting labels of multidimensional data using tensor representations), real-valued sequence labeling algorithms (predicting sequences of real-valued labels), regression algorithms (predicting real-valued labels), and sequence labeling algorithms (predicting sequences of categorical labels).

Machine learning algorithms herein can also include parametric algorithms (such as linear discriminant analysis, quadratic discriminant analysis, and maximum entropy classifier) and nonparametric algorithms (such as decision trees, kernel estimation, naive Bayes classifier, neural networks, perceptrons, and support vector machines). Clustering algorithms herein can include categorical mixture models, deep learning methods, hierarchical clustering, K-means clustering, correlation clustering, and kernel principal component analysis. Ensemble learning algorithms herein can include boosting, bootstrap aggregating, ensemble averaging, and mixture of experts. General algorithms for predicting arbitrarily-structured sets of labels herein can include Bayesian networks and Markov random fields. Multilinear subspace learning algorithms herein can include multilinear principal component analysis (MPCA). Real-valued sequence labeling algorithms can include Kalman filters and particle filters. Regression algorithms herein can include both supervised (such as Gaussian process regression, linear regression, neural networks and deep learning methods) and unsupervised (such as independent component analysis and principal components analysis) approaches. Sequence labeling algorithms herein can include both supervised (such as conditional random fields, hidden Markov models, maximum entropy Markov models, and recurrent neural networks) and unsupervised (hidden Markov models and dynamic time warping) approaches.

In various embodiments, the filter monitoring system 104 can include a power supply circuit 1022. In some embodiments, the power supply circuit 1022 can include various components including, but not limited to, a battery 1024, a capacitor, a power-receiver such as a wireless power receiver, a transformer, a rectifier, and the like.

In various embodiments the filter monitoring system 104 can include an output device 1026. The output device 1026 can include various components for visual and/or audio output including, but not limited to, lights (such as LED lights), a display screen, a speaker, and the like. In some embodiments, the output device can be used to provide notifications or alerts to a system user such as current system status, an indication of a problem, a required user intervention, a proper time to perform a maintenance action, or the like.

In various embodiments the filter monitoring system 104 can include memory 1028 and/or a memory controller. The memory can include various types of memory components including dynamic RAM (D-RAM), read only memory (ROM), static RAM (S-RAM), disk storage, flash memory, EEPROM, battery-backed RAM such as S-RAM or D-RAM and any other type of digital data storage component. In some embodiments, the electronic circuit or electronic component includes volatile memory. In some embodiments, the electronic circuit or electronic component includes non-volatile memory. In some embodiments, the electronic circuit or electronic component can include transistors interconnected to provide positive feedback operating as latches or flip flops, providing for circuits that have two or more metastable states, and remain in one of these states until changed by an external input. Data storage can be based on such flip-flop containing circuits. Data storage can also be based on the storage of charge in a capacitor or on other principles. In some embodiments, the non-volatile memory 1028 can be integrated with the control circuit 1004.

In various embodiments the filter monitoring system 104 can include a clock circuit 1030. In some embodiments, the clock circuit 1030 can be integrated with the control circuit 1004. While not shown in FIG. 10, it will be appreciated that various embodiments herein can include a data/communication bus to provide for the transportation of data between components such as an I2C, a serial peripheral interface (SPI), a universal asynchronous receiver/transmitter (UART), or the like. In some embodiments, an analog signal interface can be included. In some embodiments, a digital signal interface can be included.

In various embodiment the filter monitoring system 104 can include a communications circuit 1032. In various embodiments, the communications circuit can include components such as an antenna 1034, amplifiers, filters, digital to analog and/or analog to digital converters, and the like. In some embodiments, the filter monitoring system 104 can also include wired input/out interface 1036 for wired communication with other systems/components including, but not limited to one or more vehicle ECUs, a CANBus network (controller area network), or the like.

The filter monitoring system 104 can also include a geolocation circuit 1038. In various embodiments, the geolocation circuit 1038 can be configured to generate or receive geolocation data. In various embodiments, the geolocation circuit 1038 can receive geolocation data from a separate device. In various embodiments, the geolocation circuit 1038 can infer geolocation based on detection of a wireless signal (such as a WIFI signal, a cell tower signal, or the like). In various embodiments, the geolocation circuit 1038 can include a satellite communications circuit.

The system and/or the system control circuit 1004 can be configured to make various calculations as described herein. For example, in various embodiments, the system control circuit 1004 can be further configured to estimate expected loading rate associated with contaminants at specific geolocations based on previously observed filter loading. In various embodiments, the system control circuit 1004 can be further configured to calculate a cost associated with a particular geolocation based on estimated expected filter loading rate.

In various embodiments, the system control circuit 1004 configured to distinguish between a normal filter loading curve and an abnormal filter loading curve. In various embodiments, the system control circuit 1004 can be configured to identify a geolocation visited immediately before an abnormal filter loading curve begins. In various embodiments, the system control circuit 1004 can be configured to identify a geolocation visited immediately before a filter loading curve changes to exhibit more rapid loading. In various embodiments, the system control circuit 1004 classifies the identified geolocation as being a source of contaminants (such as airborne particulates) and stores the classification in a geolocation database. In various embodiments, the system control circuit 1004 can be further configured to generate a service parts inventory recommendation based on the geolocation database.

In various embodiments, the system control circuit 1004 can be further configured to evaluate at least one of weather data, temperature data, pressure data, humidity data, fuel filter model number, engine model number, driver ID, and detected refueling times to identify the effect of specific geolocations on filter loading.

### Methods

Many different methods are contemplated herein, including, but not limited to, methods of monitoring, methods of routing, methods of distributing inventory, and the like. Aspects of system/device operation described elsewhere herein can be performed as operations of one or more methods in accordance with various embodiments herein.

In an embodiment, a method of monitoring filters is included. The method can include generating or receiving local contaminant concentration values at the present geolocation, evaluating the filter sensor device data to determine at least one of the filter condition value and a change in the filter condition value, and generating at least one of a maintenance recommendation and a routing recommendation based on the local contaminant concentration values, time spent at the geolocation of the vehicle, duty cycle of the vehicle, the filter condition value, and a change in the filter condition value.

In an embodiment, a method of monitoring a fleet of vehicles is included. The method can include generating or receiving local contaminant concentration values at geolocations visited by vehicles in the fleet, determining an impact on filter condition of time spent at the geolocations visited by vehicles in the fleet, and estimating and storing a contaminant impact value of the geolocations visited by vehicles in the fleet.

In an embodiment, a method of providing vehicle routing information is provided. The method can include evaluating filter sensor device data to determine at least one of the filter condition value and a change in the filter condition value; receiving data relating to filter loading conditions at a plurality of geolocations, an generating a recommended vehicle route based on a starting geolocation, an ending geolocation, and the filter loading conditions at geolocations along possible routes between the starting geolocation and the ending geolocation.

In an embodiment, a method of monitoring a fleet of vehicles is included. The method can include generating or receiving local contaminant concentration values at the geolocation of vehicles in the fleet, calculating expected filter condition values based on the local contaminant concentration values associated with each vehicle in the fleet, and comparing expected filter condition values against actual filter condition values.

In an embodiment, a method of monitoring filters is included. The method can include generating or receiving local contaminant concentration values at a geolocation zone, evaluating the filter sensor device data to determine at least one of the filter condition value and a change in the filter condition value, and generating routing recommendations around the geolocation zone if the local contaminant concentration values exceed a threshold value.

In an embodiment, a method of monitoring vehicle cabin filters is included. The method can include generating or receiving local contaminant concentration values at the geolocations visited by the vehicle and generating a cabin filter maintenance recommendation based on local contaminant concentration values and time spent at the geolocations visited by the vehicle.

In an embodiment, a method of monitoring filters is included. The method can include generating or receiving local contaminant concentration values at the present geolocation, evaluating the filter sensor device data to determine at least one of the filter condition value and a change in the filter condition value, and generating a filter recommendation based on local contaminant concentration values and the filter sensor device data.

In an embodiment, a method of maintaining a vehicle fleet is included. The method can include generating or receiving contaminant concentration values at future geolocations of fleet vehicles based on routing data and directing distribution of filter maintenance products to vehicle maintenance sites based on the contaminant concentration values.

In an embodiment, a method of monitoring a vehicle fleet is included. The method can include generating or receiving local contaminant concentration values at the geolocation of each vehicle in the fleet and generating a work order for filter maintenance for fleet vehicles based on local contaminant concentration values at each geolocation visited by the fleet vehicles.

In an embodiment, a method of monitoring filters is included. The method can include generating or receiving contaminant concentration values associated with the present geolocation, evaluating the filter sensor device data to determine at least one of the filter condition value and a change in the filter condition value, and calculating an expected loading rate associated with vehicle presence in the present geolocation.

It should be noted that, as used in this specification and the appended claims, the singular forms “a,” “an,” and “the” include plural referents unless the content clearly dictates otherwise. It should also be noted that the term “or” is generally employed in its sense including “and/or” unless the content clearly dictates otherwise.

It should also be noted that, as used in this specification and the appended claims, the phrase “configured” describes a system, apparatus, or other structure that is constructed or configured to perform a particular task or adopt a particular configuration. The phrase “configured” can be used interchangeably with other similar phrases such as arranged and configured, constructed and arranged, constructed, manufactured and arranged, and the like.

All publications and patent applications in this specification are indicative of the level of ordinary skill in the art to which this invention pertains. All publications and patent applications are herein incorporated by reference to the same extent as if each individual publication or patent application was specifically and individually indicated by reference.

As used herein, the recitation of numerical ranges by endpoints shall include all numbers subsumed within that range (e.g., 2 to 8 includes 2.1, 2.8, 5.3, 7, etc.).

The headings used herein are provided for consistency with suggestions under 37 CFR 1.77 or otherwise to provide organizational cues. These headings shall not be viewed to limit or characterize the invention(s) set out in any claims that may issue from this disclosure. As an example, although the headings refer to a “Field,” such claims should not be limited by the language chosen under this heading to describe the so-called technical field. Further, a description of a technology in the “Background” is not an admission that technology is prior art to any invention(s) in this disclosure. Neither is the “Summary” to be considered as a characterization of the invention(s) set forth in issued claims.

The embodiments described herein are not intended to be exhaustive or to limit the invention to the precise forms disclosed in the following detailed description. Rather, the embodiments are chosen and described so that others skilled in the art can appreciate and understand the principles and practices. As such, aspects have been described with reference to various specific and preferred embodiments and techniques. However, it should be understood that many variations and modifications may be made while remaining within the spirit and scope herein.

1. A filter monitoring system comprising:
a filter sensor device, wherein the filter sensor device is configured to generate data reflecting a filter condition value of a filter;
a geolocation circuit, wherein the geolocation circuit is configured to determine a present geolocation of a vehicle; and
a system control circuit;
wherein the system control circuit is configured to
generate or receive local contaminant concentration values at the present geolocation;
evaluate the filter sensor device data to determine at least one of the filter condition value and a change in the filter condition value; and
generate at least one of a maintenance recommendation and a routing recommendation based on the local contaminant concentration values, time spent at the geolocation of the vehicle, duty cycle of the vehicle, and at least one of the filter condition value, and a change in the filter condition value.

2. The filter monitoring system of claim 1, wherein the system control circuit is configured to generate or receive the local contaminant concentration values for past geolocations of the vehicle and durations of time spent at the same.

3. The filter monitoring system of claim 1, wherein the filter monitoring system is an on-vehicle monitoring system.

4. The filter monitoring system of claim 1, the filter condition value comprising a filter restriction value.

5. The filter monitoring system of claim 1, the filter sensor device comprising at least one selected from the group consisting of a pressure sensor, an optical sensor, an aural sensor, an electrical property sensor, and a chemical sensor.

6. The filter monitoring system of claim 1, the geolocation circuit comprising a GPS receiver.

7. The filter monitoring system of claim 1, the local contaminant concentration values comprising airborne particulate concentration values.

8-11. (canceled)

12. The filter monitoring system of claim 1, the maintenance recommendation comprising a filter change time recommendation.

13. The filter monitoring system of claim 1, the maintenance recommendation comprising a filter type recommendation.

14-23. (canceled)

24. A filter monitoring system comprising:
a filter sensor device, wherein the filter sensor device is configured to generate data reflecting a filter condition value of a filter;
a geolocation circuit, wherein the geolocation circuit is configured to determine a geolocation of a vehicle; and
a system control circuit;
wherein the system control circuit is configured to
evaluate the filter sensor device data to determine at least one of the filter condition value and a change in the filter condition value;
receive data relating to filter loading conditions at a plurality of geolocations; and
generate a recommended vehicle route based on a starting geolocation, an ending geolocation, and the filter loading conditions at geolocations along possible routes between the starting geolocation and the ending geolocation.

25. The filter monitoring system of claim 24, wherein the system control circuit is configured to receive data relating to fuel prices at a plurality of geolocations corresponding to refueling stations and calculate the vehicle route based on the starting geolocation, the ending geolocation, and the fuel prices at the refueling stations along possible routes between the starting geolocation and the ending geolocation.

26-29. (canceled)

30. The filter monitoring system of claim 24, wherein the recommended vehicle route reflects the lowest estimated cost of vehicle operation based on parameters evaluated by the system.

31-80. (canceled)

81. A vehicle fleet monitoring system comprising:
a filter status controller, wherein the filter status controller is configured to receive data reflecting a filter restriction value of a filter of each vehicle in a fleet; and
a control circuit;
wherein the control circuit is configured to
generate or receive local contaminant concentration values at the geolocation of each vehicle in the fleet; and
generate a work order for filter maintenance for fleet vehicles based on local contaminant concentration values at each geolocation visited by the fleet vehicles and/or check inventory for a recommended filter and order or initiate an order for the same if not found in inventory.

82. The vehicle fleet monitoring system of claim 81, the work order comprising a recommended filter type.

83. The vehicle fleet monitoring system of claim 81, the local contaminant concentration values comprising airborne particulate concentration values.

84. The vehicle fleet monitoring system of claim 83, the airborne particulate comprising smoke.

85. The vehicle fleet monitoring system of claim 83, the airborne particulate comprising pollen.

86. The vehicle fleet monitoring system of claim 83, the airborne particulate comprising agricultural harvest particulates.

87. The vehicle fleet monitoring system of claim 83, the airborne particulate comprising work site particulates.

88. The vehicle fleet monitoring system of claim 81, wherein the control circuit is configured to send the work order for filter maintenance to a vehicle maintenance site along a route of the vehicle.

89-108. (canceled)
